(19) United States
(12) Patent Application Publication
(10) Pub. No.: US 2004/0010717 A1
(43) Pub. Date: Jan. 15, 2004

(54) Apparatus and method for preventing digital media piracy

(75) Inventors: Andrej Simec, Sydney (AU); Kristie Jones, Sydney (AU); Stephen Hogben, Sydney (AU); Derek Miller, Maroubra (AU)

Correspondence Address: David T. Yang, Morrison & Foerster LLP, 35th Floor, 555 W. 5th Street, Los Angeles, CA, 90013, US

(73) Assignee: INTERTAINER ASIA PTE LTD., Singapore (SG)

(21) Appl. No.: 10/210,610

(22) Filed: Jul. 31, 2002

Related U.S. Application Data
(60) Provisional application No. 60/353,076, filed on Jan. 29, 2002.

(51) Int. Cl. H04L 9/00; G06F 12/14

(52) U.S. Cl. 713/201; 713/150; 705/58

(57) ABSTRACT

The present invention is directed to a digital verification and protection (“DVP”) system that can be implemented to protect against piracy or unauthorized reproduction of digital content that is delivered from a content provider to an end user of the content. Specifically, the preferred embodiments of the present invention detects the configuration or setup of the viewing or downloading equipment of the end user to determine whether the detected configuration or setup, including hardware and/or software setup, that may be used by the end user to copy or pirate the digital content to be delivered to the end user. Additionally, the present invention may be used by the content provider to require a specific minimum viewing or downloading equipment setup, such as a minimum processor speed, as precondition to accessing or viewing the digital content being requested by the end user.

### CROSS-REFERENCE TO RELATED APPLICATIONS

Embodiments of the present invention claim priority from U.S. provisional patent application Serial No. 60/353,076 filed Jan. 29, 2002.

### BACKGROUND

1. Field of Invention

The present invention is directed to a digital media piracy threat response system that protects digital media from unauthorized reproduction.

2. Description of Related Art

This present invention is directed to preventing illegal or unauthorized copying of information and other media content or services provided over a network (either public network, such as the Internet, or privately owned, such as a LAN).

Internet-based entertainment services rely heavily on the use of streaming and downloading to deliver video and audio content to consumers. In a streaming scenario, the digital media are stored on a server and a client-resident media viewer is used to receive and display audio/video frames as they are “streamed” across a network from the server, without storing the media on the client. In a download scenario, the digital media are stored on a server and copied across a network to a storage device on the client for subsequent playback via a client-resident media viewer. One of the key problems with both of these approaches is the risk of the digital media asset being captured by the end user and then re-distributed against the asset owner's wishes.

In many cases, such media delivery systems rely upon an encryption scheme to protect against piracy, commonly referred to as Digital Rights Management (DRM). Under this scheme, digital media files are encrypted using a private key known only to the rights-holder or its authorized distributor. The digital media are delivered to the client and decrypted using a public key exchanged between the server and the client upon successful user authentication and authorization. Authentication/authorization is usually accompanied via some form of payment to the rights holder or distributor. This is usually sufficient to protect against unauthorized viewing of digital media files.

There are a variety of mechanisms available to the would-be digital media pirate when faced with a DRM-only (or similar type encryption/watermark) protection scheme. In displaying the media, the client-side viewer first decrypts and then decodes the media (converts the media from digital to analog format) for presentation on analog devices. The result is a series of video frames presented to the user. DRM does not protect against copying the decoded video frames. In essence, once the content is decrypted and decoded, it is unprotected and available to be copied in digital or analog form.

By the time the digital media is presented to the viewer, it has been fully uncompressed and displayed on the computer screen. This image is a bitmap in memory, and all timing and signals are available on the video card bus. It is possible to capture and record these signals off the feature connector on a video card. Once captured, a simple set of algorithms may be used to regenerate the original uncompressed movie, as presented by the media player. All that remains is to make a master for duplication. FIG. 1 is a graphical illustration of a hypothetical digital path from the streaming computer to the final product of encoded Video-CD (VCD). As FIG. 1 shows, digital data is captured from the video card II by the digital recording device 12, which can then deliver the recorded digital data with a PC 13 that may use a CD-RW to encode a VCD 14.

Even though it is generally possible to get a digital recording from the streaming computer, suitable hardware is required, and the process is beyond the casual pirate. A much easier and quicker way is to use the analog output. More specifically, analog recording from a computer is possible via a scan converter. Coupled with a quality analog to digital scan converter, the results will be as good as the streaming or downloaded digital media. With further equipment it is possible to take a digital copy with which to create re-encoded output, suitable for the creation of a Video-CD (VCD).

Specifically, as FIG. 2 shows, the uncompressed frame is presented to the viewer via a PC 20. This is in most cases via a 15 pin D-Shell cable plugged into the back of a computer and that cable connects to the computer monitor. A common scan converter 21 is all that is required to take the signal bound for the monitor and turn it into a signal capable of being displayed on a television screen 23, projector 22, or a recording device such as a camcorder 24 or a video recorder 25. The output from the scan converter 21 can vary depending on the quality (usually directly related to price). Most offer S-Video output or even a component output, an excellent reproduction quality for analog recording. While most high-end PCs have a graphic card that is capable of presenting a TV-compatible signal, the quality is presently inferior to that achieved through a scan converter.

There are consumer products available that allow the capture and conversion of analog signals into a format suitable for archiving to a digital medium such as digital videotape. From there it is a small step to re-encode the movie via a computer 26 to be used as a master for a VCD 27, and then a CD-ROM burner for the small-scale pirate—or a CD Stamper for larger scale operations. The VCD has enjoyed wide popularity and is a widely accepted format within the Asian market, so much so that most DVD players now on the market play back VCD movies.

The analog piracy problem has been faced by the video community before. With the introduction of DVD's it would have been possible to record good quality copies straight off the DVD using the analog output. This is defeated using digital watermarks or steganographically embedded data, which were initially introduced by companies such as Macrovision to inhibit piracy of VHS recordings. A similar system could be implemented on scan converters to stop an analog recording such as the scenario of FIG. 2, but this solution is impractical and may lead to more problems with normal uses of projection units and televisions.

### SUMMARY OF THE INVENTION

The present invention is directed to a digital verification and protection (“DVP”) system that intelligently prevents digital media piracy through methods of threat response, and mitigates the need for the post-breach forensic diagnostic process common in many traditional digital media protection systems. The preferred embodiments of the present invention aids in protection against the unauthorized copying of digital media that are delivered to personal computers (PC) or to television sets via set-top boxes (STB). The invention protects against piracy in both streaming and downloaded digital media. In high-level terms, the preferred embodiments of the present invention, among other features,:

a) Positively identifies a known piece of equipment, device, or software, and searches for digital or analog outputs or its equivalents,

b) Permits digital media playback only to viewing or downloading equipment of devices of known and approved configurations; and

c) Identifies equipment configuration changes in real-time and determine if such changes constitute a breach of security.

It is an object of the present invention to provide protection against piracy of digital content by disallowing playback on devices that provide a mechanism by which the decrypted and decoded media may be copied. In a DVP system in accordance with the preferred embodiments of the present invention, a consumer who wishes to view or use digital content must gain permission before it may access or display digital media (notwithstanding the fact that the digital media may or may not be additionally protected with conventional anti-piracy measures such as DRM). A consumer may gain permission to gain access to the digital content if, in accordance with the present invention, the consumer's hardware and software configuration or setup do not pose as threats (i.e., cannot be used to reproduce the digital content without authorization). Further, in accordance with the preferred embodiments of the present invention, upon detecting a change in configuration of the consumer's viewing or downloading setup, the delivery of digital content is automatically stopped and must regain permission to the digital media.

It is another object of the present invention to maintain a database of device or software configuration information, such as peripherals and applications, that may be classified as either acceptable or unacceptable configurations of setups for a consumer to have prior to gaining permission to access digital content. Specifically, in accordance with a DVP system of the present invention, the database is used to determine if a particular device configuration poses a threat to the digital media that have been requested. For example, if a digital recording device is attached to the user's PC, then the present invention may be programmed to determine that a threat exists, and the request for digital media is denied. In the case an unknown configuration is detected, the database is updated, and a threat examination process is preferably carried out that result in an expansion of the system's ability to accurately detect and respond to potential threats.

One advantage of the present invention is security of protected information, copyright information, and media services. Specifically, the present invention ensures that information is only sent to and can be accessed only by parties whose configuration and setup are approved by the owner of the digital content to be delivered. Furthermore, this system ensures that media may only be presented on devices approved by the asset owner. This system prevents the unauthorized copying or reproduction of information displayed on an individual's PC or media display devices such as a television.

It is another object of the present invention to notify digital content owners when an unapproved user, device, or activity is taking place, and allows the digital content owner to respond as required, with an appropriate security policy or measure.

While the embodiments of the present invention are preferably used in conjunction with Video On Demand (VOD) systems, the present invention is widely applicable to any other system in which digital media content is delivered from one party to another. In particular, the invention may be employed in any application in which digital media are delivered to personal computers (“PC”), set top boxes (“STB”), or similar devices, in which there is an interest on the part of the rights-holder or owner to protect the digital media from unauthorized reproduction or usage. A system in accordance with the present invention may be employed regardless of the means by which the digital media are delivered to the client device, and can be employed as .an additional layer of digital media protection scheme beyond conventional protection systems against piracy.

### BRIEF DESCRIPTION OF THE DRAWINGS

FIG. 1 is an illustration of a possible path for digital content from a computer to encoded VCD;

FIG. 2 is an illustration of a possible recording or reproduction scheme using digital-to-analog converting devices;

FIG. 3 is an illustration of the architecture of a digital verification and protection (“DVP”) system in accordance with the preferred embodiment of the present invention;

FIG. 4 is an illustration of the operating characteristics of a DVP system in accordance with the preferred embodiment of the present invention;

FIG. 5 is another illustration of the operating characteristics of a DVP system in accordance with the preferred embodiment of the present invention;

FIG. 6 is yet another illustration of the operating characteristics of a DVP system in accordance with the preferred embodiment of the present invention;

FIG. 7 is an illustration of the architecture of the DVP system in accordance with an alternative embodiment of the present invention;

FIG. 8 is an illustration of the architecture of the DVP system in accordance with another alternative embodiment of the present invention;

FIG. 9 is an illustration of a specific implementation of the DVP system in accordance with the preferred embodiment of the present invention;

FIG. 10 is an illustration of another specific implementation of the DVP system in accordance with the preferred embodiment of the present invention;

FIG. 11 is an illustration of another specific implementation of the DVP system in accordance with the preferred embodiment of the present invention;

FIG. 12 is an illustration of yet another specific implementation of the DVP system in accordance with the preferred embodiment of the present invention;

FIG. 13 is an illustration of yet another specific implementation of the DVP system in accordance with the preferred embodiment of the present invention;

FIG. 14 is an illustration of yet another specific implementation of the DVP system in accordance with the preferred embodiment of the present invention;

FIG. 15 is an illustration of yet another specific implementation of the DVP system in accordance with the preferred embodiment of the present invention;

FIG. 16 is an illustration of yet another specific implementation of the DVP system in accordance with the preferred embodiment of the present invention;

FIG. 17 is an illustration of yet another specific implementation of the DVP system in accordance with the preferred embodiment of the present invention;

FIG. 18 is an illustration of yet another specific implementation of the DVP system in accordance with the preferred embodiment of the present invention; and

FIG. 19 is an illustration of yet another specific implementation of the DVP system in accordance with the preferred embodiment of the present invention.

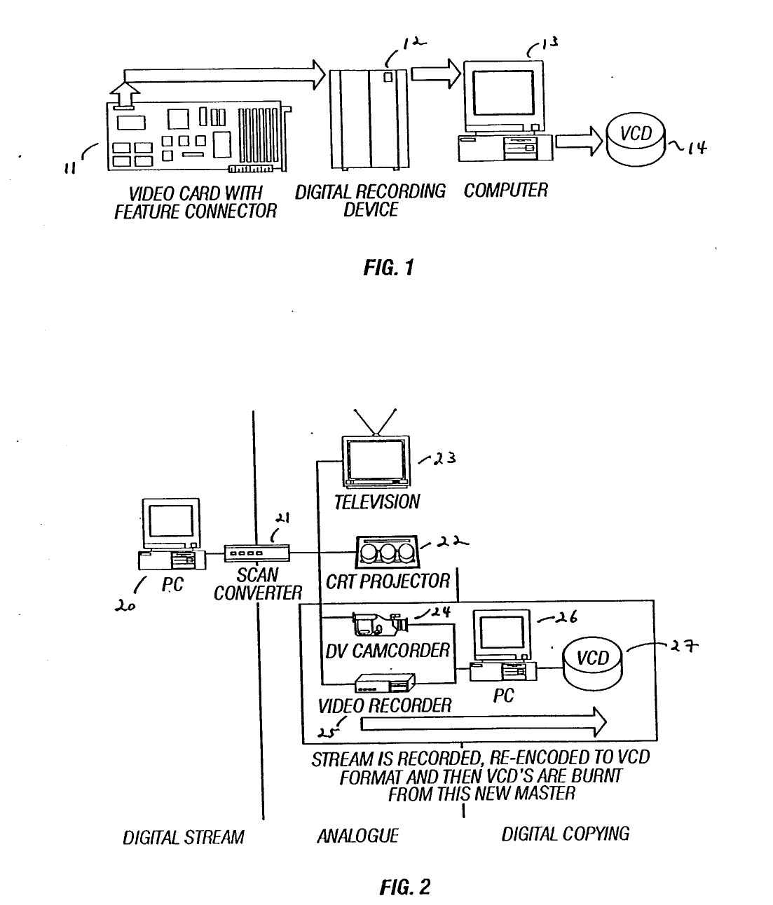

### DETAILED DESCRIPTION OF THE PREFERRED EMBODIMENTS

The present invention is directed to an apparatus and method for protecting digital content from being pirated or otherwise reproduced without authorization. A DVP system in accordance with the preferred embodiments of the present invention make a risk decision based on the examination of a user's viewing equipment configuration at the beginning of streaming each digital content, such as a movie. Specifically, if the DVP system detects that the user's download or viewing equipment configuration includes a recording device, such as an active plug-in recording device on a computer or a VCR connected to a set top box, then the DVP may be directed to deny delivery of the digital content to the user. Additionally, the DVP system can be used to monitor the users equipment configuration during the entire download or viewing session, and can interrupt or stop the delivery of digital content if there is any change to the users equipment such as an addition of a recording device to the equipment configuration or setup.

In accordance with the preferred embodiments, the DVP system uses heuristic algorithms to recognize a potential threat. The process begins when a client device first attempts to access digital media. At that time, DVP registers the client device's relevant hardware and software profile. In constructing this profile, the system searches for certain device and software “fingerprints” that are known to provide information necessary to make a threat determination.

Having captured and registered a client device profile when the device is first encountered, the DVP system improves threat determination performance by comparing that client device's profile with the registered profile on subsequent occasions. The system then only goes through a full threat determination process when the current and registered profiles are different in some way. This provides an optimal user experience, without sacrificing security in a significant manner.

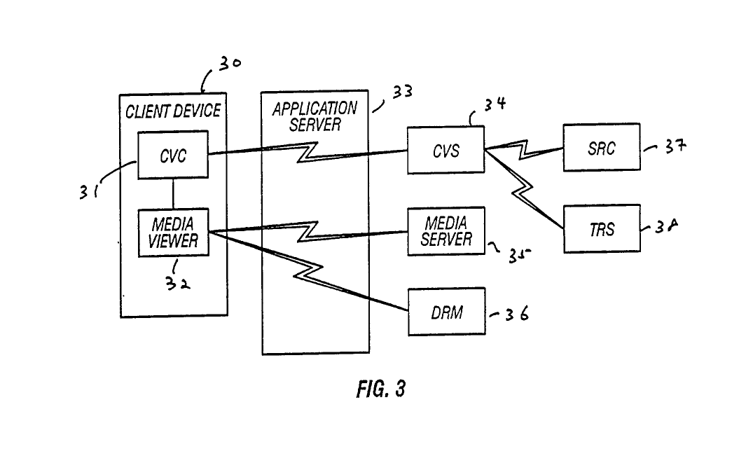

The preferred embodiments of the present invention will now be described with references to FIGS. 3-19.

FIG. 3 illustrates a DVP system architecture in accordance with the preferred embodiment of the present invention. Specifically, the DVP system in accordance with the preferred embodiment includes a media server 35, which stores digital media content (either in encrypted or unencrypted form). The DVP system in accordance with the preferred embodiment also includes a client device 30, which includes either a personal computer (“PC”), a set top box (“STB”), and any other device used to display digital media. For instance, a typical client device may include a television and a set top box. Another typical client device may include a personal computer and a display monitor.

The DVP system in accordance with the preferred embodiment also includes: a media viewer 32, which may be any device for causing the display of digital content (such as a set top box), including any device that converts digital signals into analog signals for presentation; an application server 33, which coordinates download or viewing requests from the client to the server/distributor, a stream release criteria server (“SRC”) 37, which stores device configurations or setups that are determined to be acceptable configurations or setups for receiving the digital content to be delivered; a threat repository server (“TRS”) 38, which stores questionable or unknown device configurations, and preferably logs the usage of such configurations; a configuration verification server (“CVS”) 34, which mediates requests for media viewing; a configuration verification client (“CVC”) 31, which determines the device configuration or setup of an user, and provides the information to the CVS; and a digital rights management server (“DRM”) 36, which authorizes requests for encrypted media and provides a decryption key.

It should be noted that, while the various components described above are illustrated in FIG. 3 as separate hardware devices, it is within the scope of the present invention to implement the above-described functions via various software implementation methods while sharing the same hardware resources.

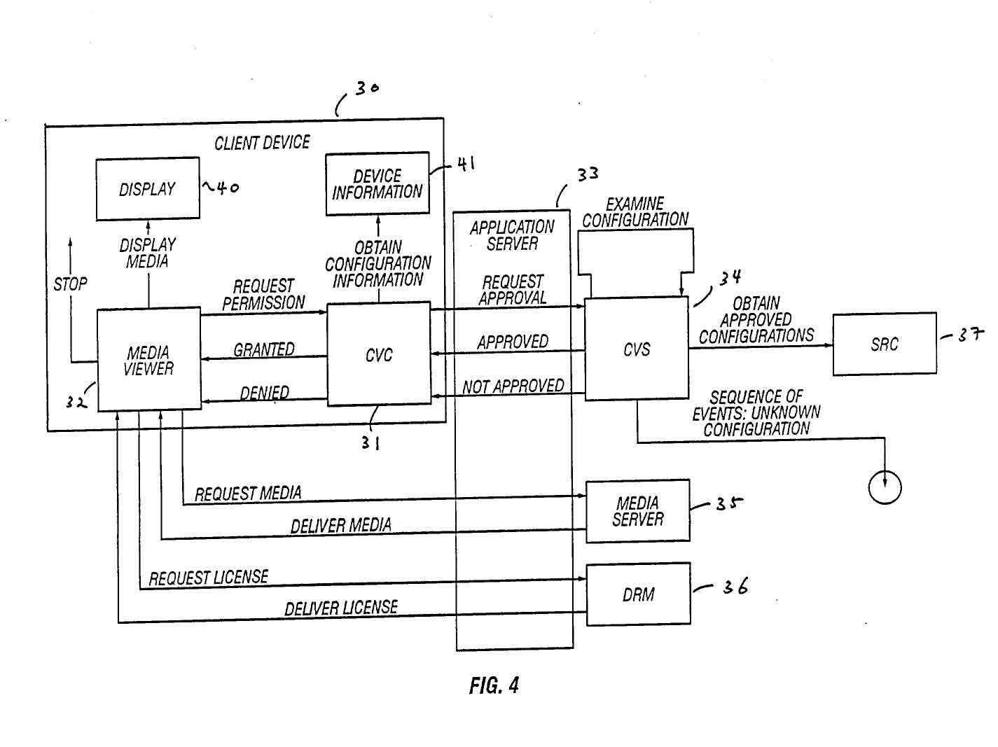

FIG. 4 illustrates a typical operation schematic of a DVP system in accordance with the preferred embodiment of the present invention. Specifically, a consumer, using the client device 30, first requests permission from the content provider to access digital media, the request being routed through the CVC 31 that preferably resides within the client device or otherwise has access to the client device 30. Upon receiving the request, the CVC 31 obtains configuration or setup information from the client device 30, and forwards or causes the information to be forwarded to CVS 34 for examination and approval. Upon receiving the approval request from the CVC 31 or the client device 30, the CVS 34 retrieves or looks up from the SRC 37 a list of acceptable and unacceptable configuration(s) or setup(s) that have been pre-approved with a predetermined approval criteria.

Upon receiving the list of acceptable/unacceptable configuration or setups, the CVS 34 compares the client device 30 configuration or setup against the retrieved or looked-up list of acceptable configuration(s) or setup(s). In the case that the CVS 34 determines the client device 30 configuration or setup is acceptable, then the CVS 34 notifies the CVC 31 that the request for digital content has been approved. Once the CVC 31 receives a notice from the CVS 34 that the user is authorized to view the requested digital content, then the CVC 31 notifies the client device 30 that the request has been approved. Thereafter, the media viewer 32 requests the digital content from the media server 35, which then delivers the digital content to the media viewer 32.

It should be noted that, in detecting the client device 30 configuration, the CVC 31 preferably can also detect, in addition to hardware, residence of unauthorized software, overriding of Macrovision measures, ripping software, hacked or “fake” DRM or encryption software, users running illegal configurations through what are called “Trojan software” (which could be something that looks like an authorized software but us really a piece of ripping software). The DVP system in accordance with the preferred embodiment preferably can detect Trojan software and rogue software processes through checking the “DLL Signature” of each process that is running. This is a bit like DNA testing. For example a piece of ripping software is characterized by the way it uses DLLs and other processes. Just renaming it as something else (like Word or Outlook) doesn't deceive DVP because it recognizes that the DLL signature of this process that claims to be Outlook or Word resembles a piece of ripping software, not Outlook or Word.

In accordance with another embodiment of the present invention, if the DVP system is used in conjunction with a conventional encryption or watermark security system, then additional security measures can be taken. For instance, in FIG. 4, the digital content can be delivered to the media viewer 32 in encrypted form, after which the media viewer 32 must request a license or authorization from the DRM 36, which may determine at that time whether to grant authorization and deliver to the client device 30 the appropriate decryption key or other similar access means to view the delivered digital content.

In FIG. 4, if the CVS 34 determines that the client device configuration or setup is not acceptable, then the CVS 34 notifies the CVC 31 that the request for digital content is denied. The CVC 31 in turn notifies the user, preferably via the media viewer 32, that the request for digital content is denied. In accordance with the preferred embodiment of the present invention, the DVP system can also display messages to the user explaining the reasons why the request for digital content was denied, such as pointing out a particular device or software connected to the client device that may pose as a threat to digital piracy.

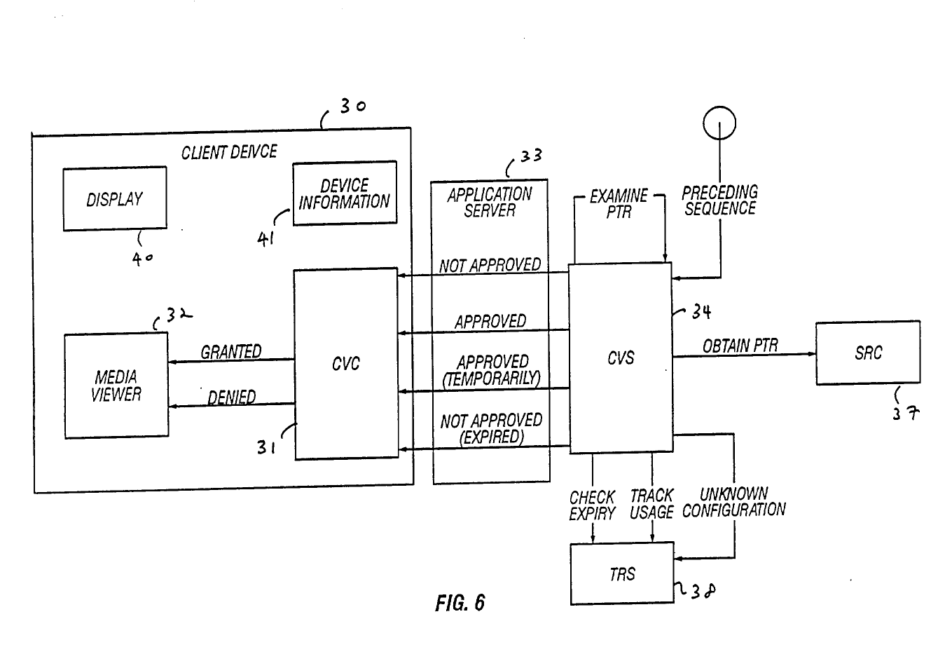

Finally, if the CVS 34 in FIG. 4 determines that the client configuration or setup is not contained within the retrieved list of configuration and/or is otherwise unknown, then the CVS 34 proceeds to take the steps illustrated in FIG. 6. FIG. 6 illustrates the operation of the DVP system of the present invention in the event that the CVS 34 encounters an unknown client device configuration or setup. In particular, the CVS 34 sends the detected questionable client device configuration to the TRS 38 for update of database on unknown client device configurations, the data being able to be later (or concurrently) used by content providers to analyze for its threat to digital piracy.

Meanwhile, the CVS 34 retrieves from the SRC 37 a list of potential threat responses that may be taken in response to the unknown client device configuration detected, such response options being preferably based upon the digital content requested and the geographical location of the requesting client device. The potential threat response to an unknown user client device configuration can be simply a denial of digital convent delivery, granting permission for digital content delivery, or granting temporary digital content delivery pending subsequent conditions being satisfied (such as the user changing his or her client device configuration within a specified time period).

If the event that the potential threat response dictates granting of request for digital content delivery, then the CVS 34 preferably notifies the TRS 38 of such result, and the CVC 31 and media viewer 32 are preferably notified of the request being granted. In the event that the potential threat response dictates denial of request for digital content delivery, then the CVS 34 preferably notifies the TRS 38 of such result, and the CVC 31 and media viewer 32 are preferably notified of the request being denied.

In the event that the potential threat response dictates temporary delivery of digital content, the CVS 34 preferably logs such result with the TRS 38, and requests the TRS to check the expiration condition, or continuation condition, of the digital content delivery. The condition for continuing digital content delivery is preferably related to the user via the client device 30, and the CVS 34 then preferably checks the status of the temporary condition from time to time to determine whether the conditions for continuing the digital content delivery is being met. If the required conditions are not met, then the digital content delivery is ceased, with the user being notified of the same. The form of temporary permission may vary. For example, one possible client device configuration or user profile may dictate that the temporary permission be extended for 30 days, while another may allow 10 approved separate access to the requested digital content.

In summary, there are at least three possible conditions encountered by the DVP system when a client device configuration is examined against configurations known to the SRC:

| | |
|---|---|
| Non-threatening | Configuration is known to the SRC 37 and no threat |
| | is detected |
| Threatening | Configuration is known to the SRC 37 as a threat |
| Unknown | Configuration is unknown to the SRC 37 |

As discussed previously, threat determination is variable based on a number of factors, including media owner, geographic region, and so on. In determining the response, the system takes into account all threat determination factors before determining if the condition is non-threatening, threatening, or unknown.

As also previously addressed, it is important to note that while the devices and their functions are described as separate hardware modules for purposes of explaining the present invention is a clear manner, it is contemplated within the scope of the present invention that many of these functions can be embodied in different hardware or software implementations or schematics to provide the same functions and results.

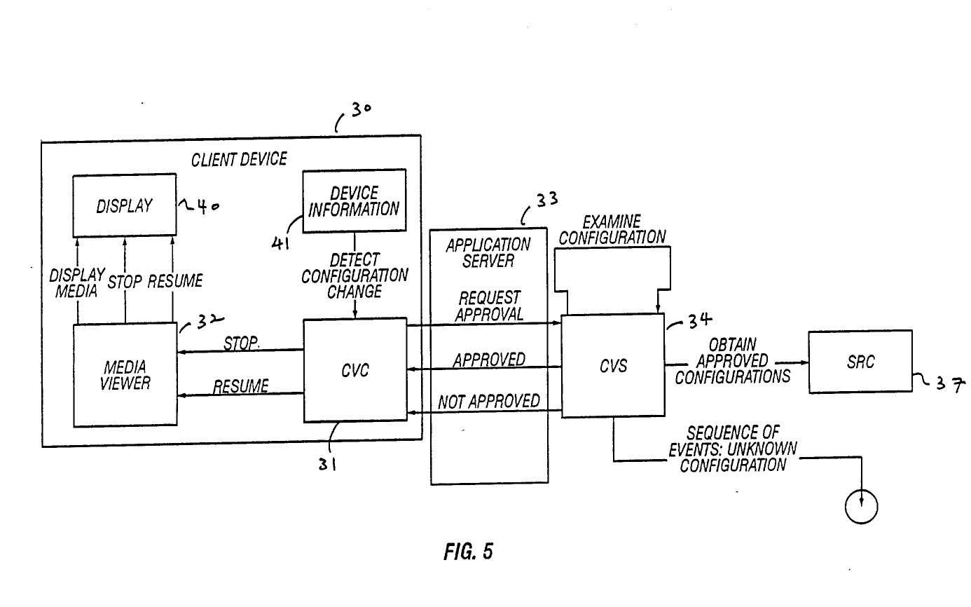

FIG. 5 illustrates the operations of the DVP system in accordance with the present invention in the event that new hardware or software are introduced to the client device 30 during the download or delivery of digital content to the user. Specifically, if, while the media viewer 32 is displaying or otherwise delivering digital content to the client device, the CVC 31 detects a configuration change in the client device 30, when the CVC 31 preferably directs the media viewer 32 to halt the delivery of digital content. Additionally, the CVC 31 forwards the updated client device configuration to the CVS 34, which then compares the updated client device 30 configuration to that of the retrieved list of acceptable/unacceptable configuration or setup from the SRC 37.

If, upon examination of the CVS 34, the DVP system determines that updated client device 30 configuration is unacceptable, then the CVC 31 is directed to cause the digital content delivery to terminate, and to cause the client device to notify the user of such action by the DVP system. If the CVS 34 determines the updated client device 30 configuration is acceptable, then the CVC 31 is directed to cause the digital content delivery to resume. If the CVS 34 determines that the updated client device 30 configuration is unknown, then the process described in FIG. 6 will take place.

Over time, the complexity of the client device configuration may increase while the DVP system becomes more aware of potential threats and the techniques necessary to identify threatening devices and software. In effect, the DVP system in accordance with the present invention evolves and becomes more intelligent in its threat determination.

The DVP system may learns of additional threats in a variety of ways. In particular, when the system reports an unknown configuration to the TRS 38, a human expert in threat determination may analyze the configuration and informs the system of the results through an administrative interface. Once this determination has been made, the DVP system “understands” the configuration and is able to make an automatic threat determination in the case that a similar configuration is identified again.

As new devices and software become available to consumers, those devices are examined by human experts or artificially intelligent programs to determine threat to digital piracy and described to the system through an administrative interface. Afterward, the system is able to automatically perform threat determination on such configurations. Additionally, different content owners may have varying opinions regarding acceptable client device configurations. For example, one content provider may require that their content be played only on devices that do not have video adapters with S-Video connectors, while another may have no such restriction. Further, it may be that the same media owner has different concerns regarding specific types of media (e.g., first-run movies), or may have different concerns based on geographic area. In anticipation of such circumstances, the system allows for varying threat profiles per media owner, per media item, and per geographic area. The DVP system of the present invention can be configured to adapt as new threat profiles are introduced. For example, in the future a content provider may perceive that a certain networking protocol poses a threat. In this circumstance, the DVP system is adapted to detect such network protocol and further protect that media owner's content according to the updated threat profile.

In a DVP system in accordance with the preferred embodiment of the present invention, if the CVC 31, be it either hardware or software, is somehow tampered, disabled, or malfunctioning, either due to actions by the user or otherwise, then all digital content delivery request is preferably denied until the CVC operates correctly again.

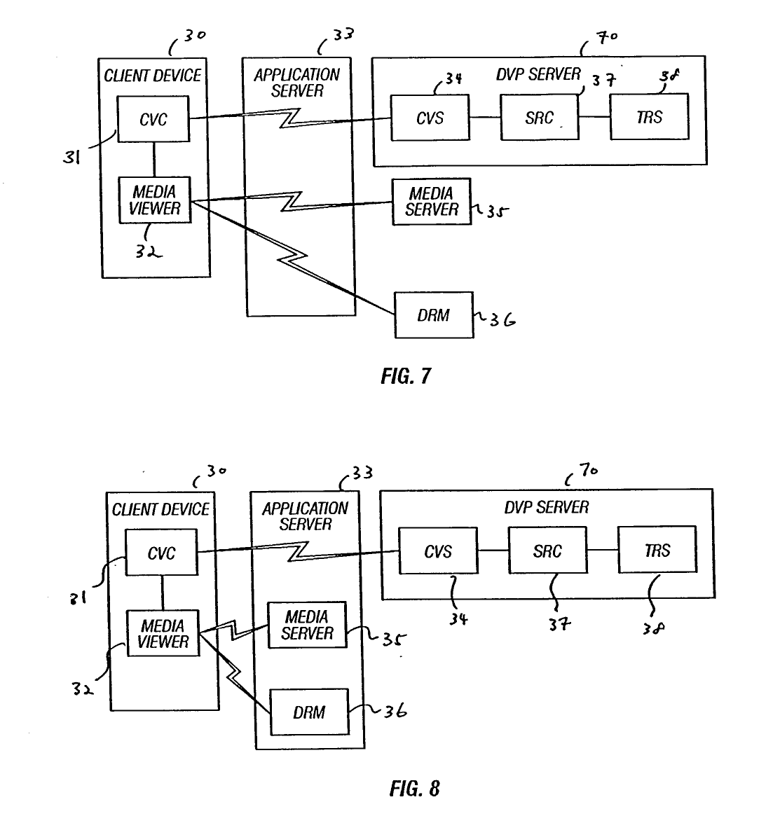

Again, the present invention has thus far been described in certain terms regarding server and network architecture. It should be noted however that the architectural specifics thus far described are merely illustrative, and should not be considered the sole instance of the invention. Rather, the DVP implementation may vary in many instances, especially relating to network and server architecture. Specifically, while the preferred embodiment of FIGS. 3-6 describe the various servers as being connected by a network, a specific instance of the DVP system may have two or more servers contained within the same physical computing device and communicating within that device rather than across a network. FIG. 7 illustrates a DVP system in accordance with an alternative embodiment of the present invention. As shown, the CVS 34, SRC 37, and TRS 38 are all contained within the DVP server 70. FIG. 8 illustrates another alternative embodiment of the present invention whereby the media server 35 and DRM 36 are contained within the application server 33.

It should also be noted that, while the primary purpose of the present invention is directed to protection against piracy or unauthorized reproduction of digital content, the present invention may also be used to specify minimum client device requirements for receiving certain digital content. For instance, some media owners may require that a client device must meet certain minimum specifications in terms of hardware, operating system, software, and so on. Often, such requirements stem from a concern over media playback quality. For instance, a media owner may believe that devices will present their media with insufficient quality unless the devices have a CPU above some certain performance specification or have a particular graphics processing capability. In another example, the digital content provider may require that the client device be equipped with certain parental control measures before delivering digital content of adult nature. The core of present invention, the ability to determine a client device configuration and compare that configuration to acceptable configurations, is ideally suited to ensure that a device meets minimum specifications. In essence, some may view devices not meeting such minimum specifications as a threat to quality rather than security.

Finally, the present invention is applicable not only to streaming and downloaded digital video, but also to digital audio. The invention is easily implemented to protect against digital music piracy.

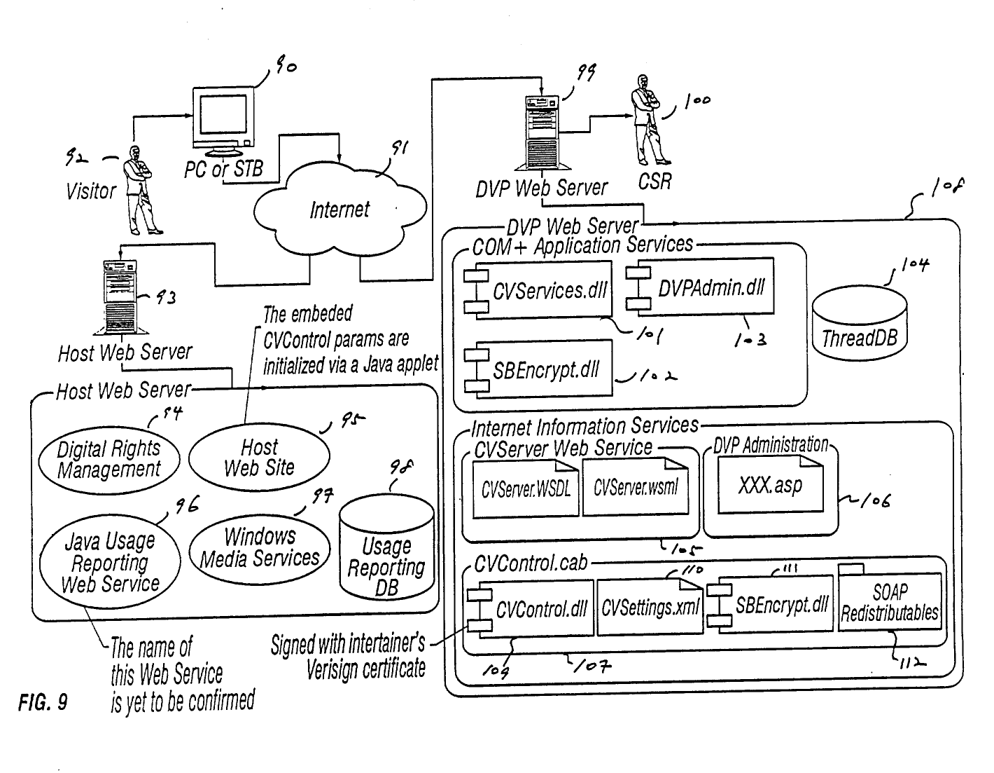

FIG. 9 shows a specific implementation of a DVP system in accordance with the preferred embodiment of the present invention. Specifically, in this specific implementation, the client device is a PC or set-top box 90 running Microsoft Windows operating system, and the consumer uses the Internet Explorer web browser to access a host web site that lists available digital content. The CVC is an ActiveX control embedded in a web page, interacting with the client device through the Microsoft WMI (Windows Management Instrumentation) interface. The media viewer is Windows Media Player, and the DRM server is Microsoft Media Rights Manager. The Application Server is a Microsoft IIS Web Server, and the CVS runs under IIS as a web service. The CVC and CVS communicate securely via SOAP (Simple Object Access Protocol). TRS and SRC are a Microsoft SQL Server 2000 database, under control of the CVS. In FIG. 9, the equivalent of a CVC 31 is the CV Control.dll 109, the equivalent application server 33 is the DVP web server 108, the CVS 34 equivalent is the CVServices 106, and the TRS 38 and SRC 37 equivalent is the ThreatDB 104.

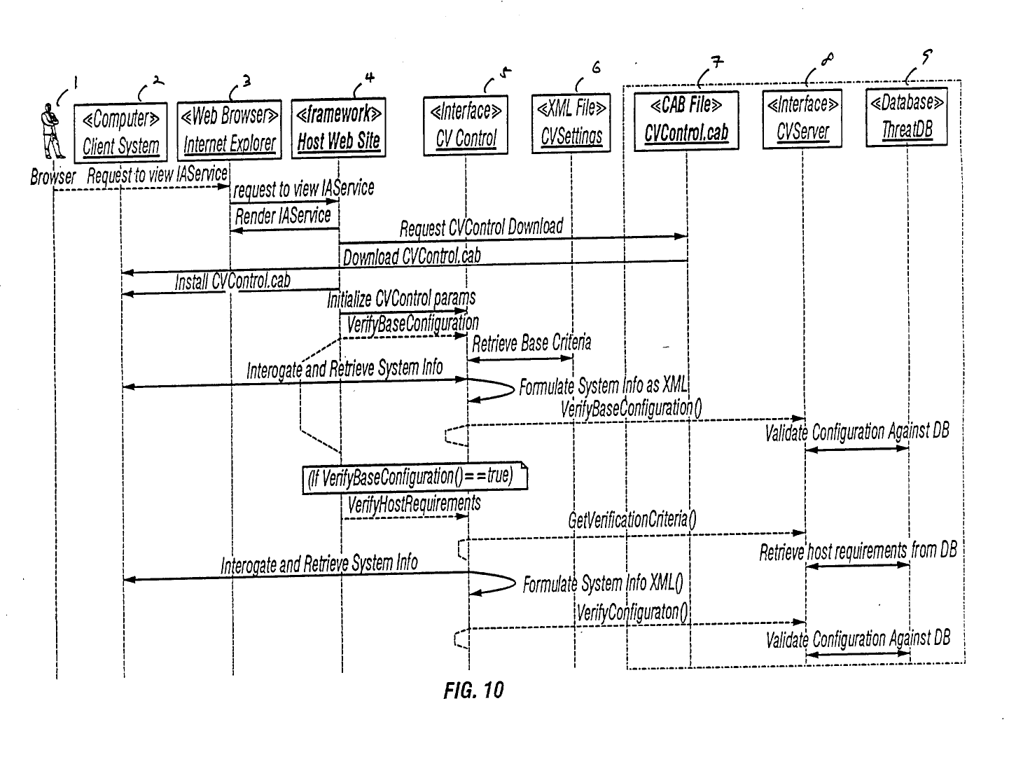

FIG. 10 is another illustration of a specific implementation of certain aspects of the preferred embodiment of the present invention. Specifically, FIG. 10 illustrates a sequence diagram depicting the sequence of events that occur upon downloading the CVC as software to a user's computer.

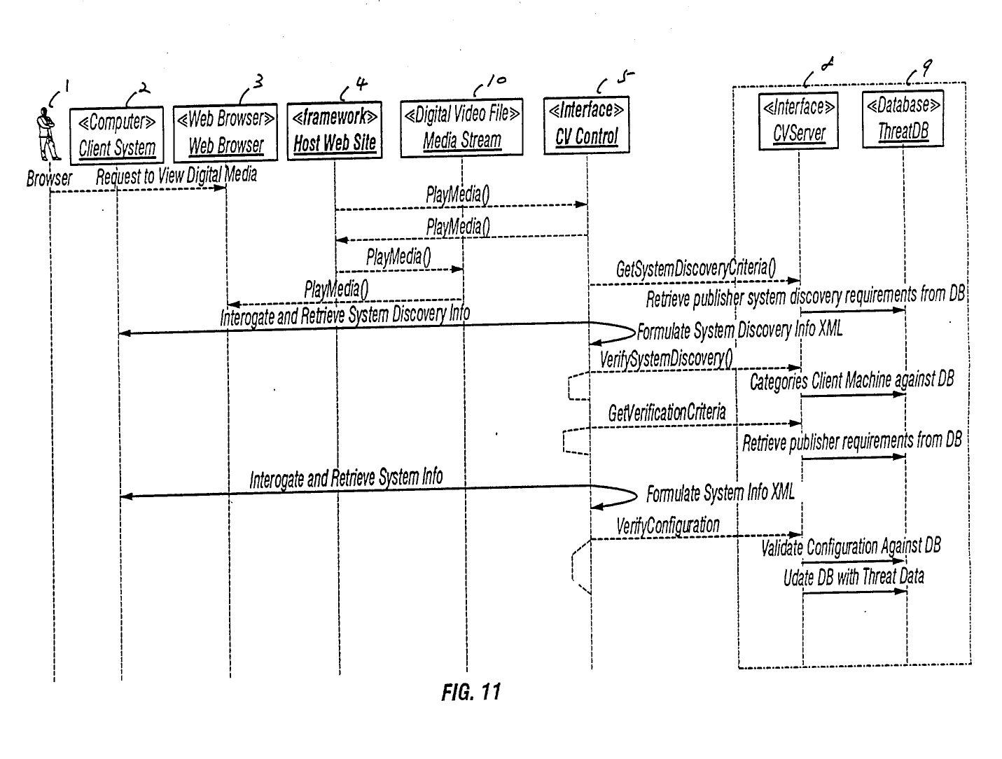

FIG. 11 is yet another illustration of a specific implementation of certain aspects of the preferred embodiment of the present invention. Specifically, FIG. 11 illustrates a sequence diagram depicting the sequence of events that occur when a host web site visitor elects to request and view the digital content.

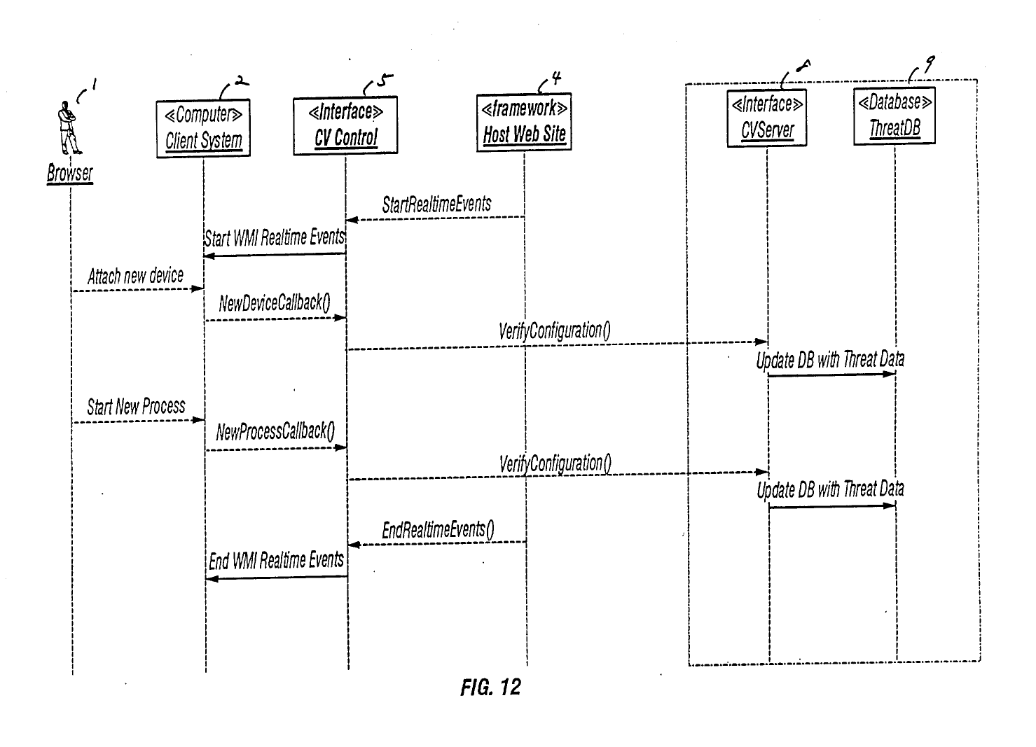

FIG. 12 is yet another illustration of a specific implementation of certain aspects of the preferred embodiment of the present invention. Specifically, FIG. 12 illustrates a sequence diagram depicting the sequence of events that occur when a user starts a new process or connects a new device to the client device while viewing or using the digital content being delivered.

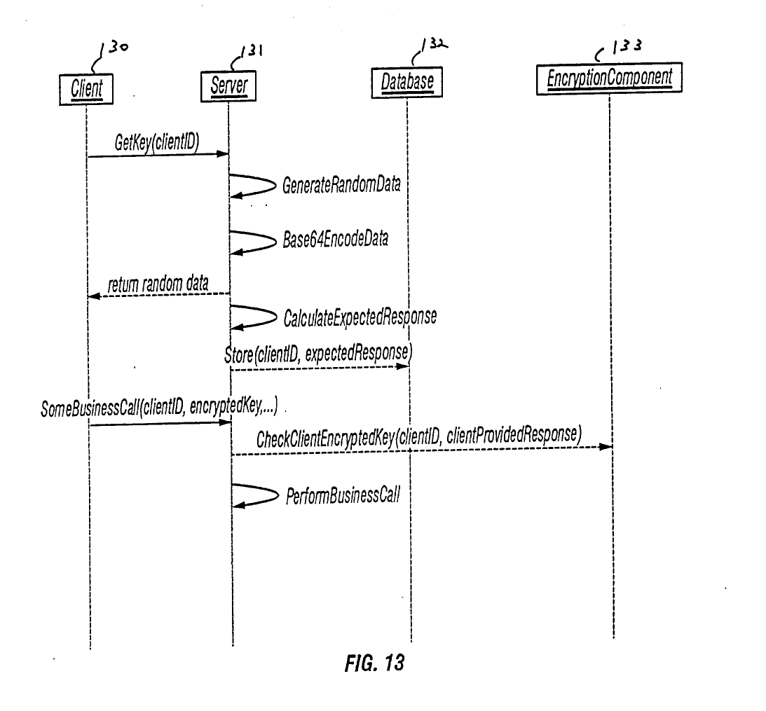

FIG. 13 illustrates a sequence diagram illustrating the basic web service security protocol. Specifically, a client requests some random data from the server, encrypts this data, and sends this data back to the server as a parameter with the business call. The server encrypts the data that it gave the client, compares the encrypted data returned by the client, and if the data matches, the server performs the actual business call. The password used to encrypt the data on both sides is exchanged out-of-band. The encrypted data is returned to the server in a base-64 encoded form so that it can be transported using a SOAP (Simple Object Access Protocol) string. The return value for the business function indicates if authentication fails.

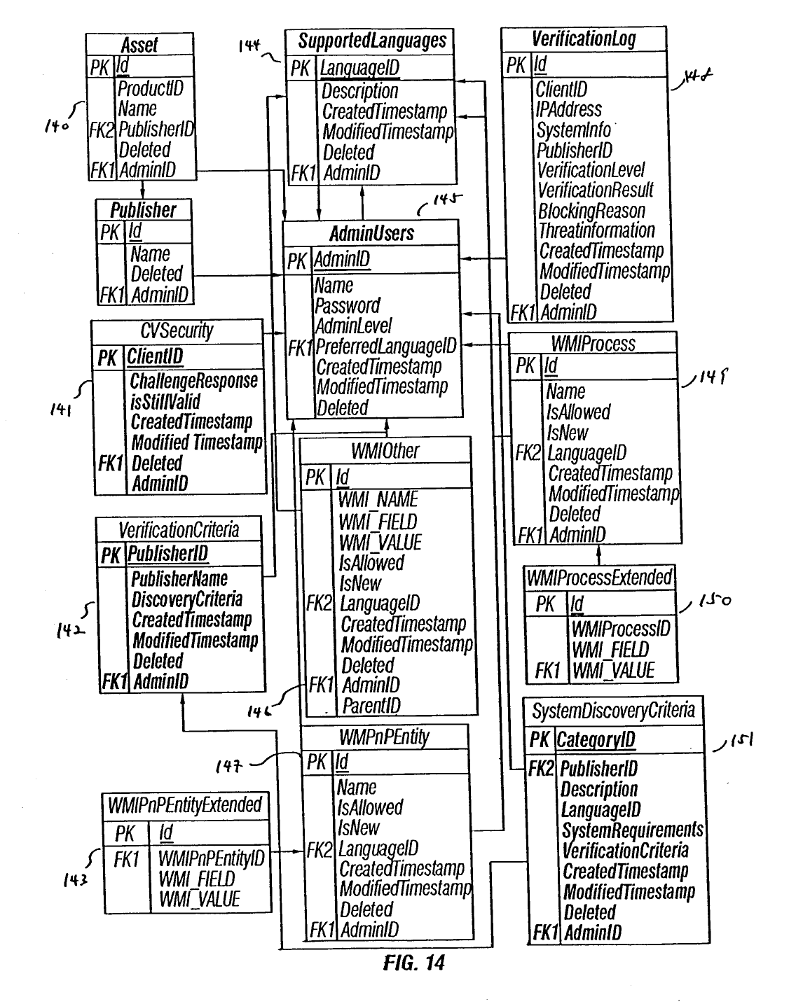

FIG. 14 is an entity-relationship diagram depicting a specific implementation of the data scheme of the CVS 34 in accordance with the preferred embodiment of the present invention. It is important to note that FIG. 14 is merely illustrative and that many alternative database scheme may be implemented in accordance with the preferred embodiment of the present invention.

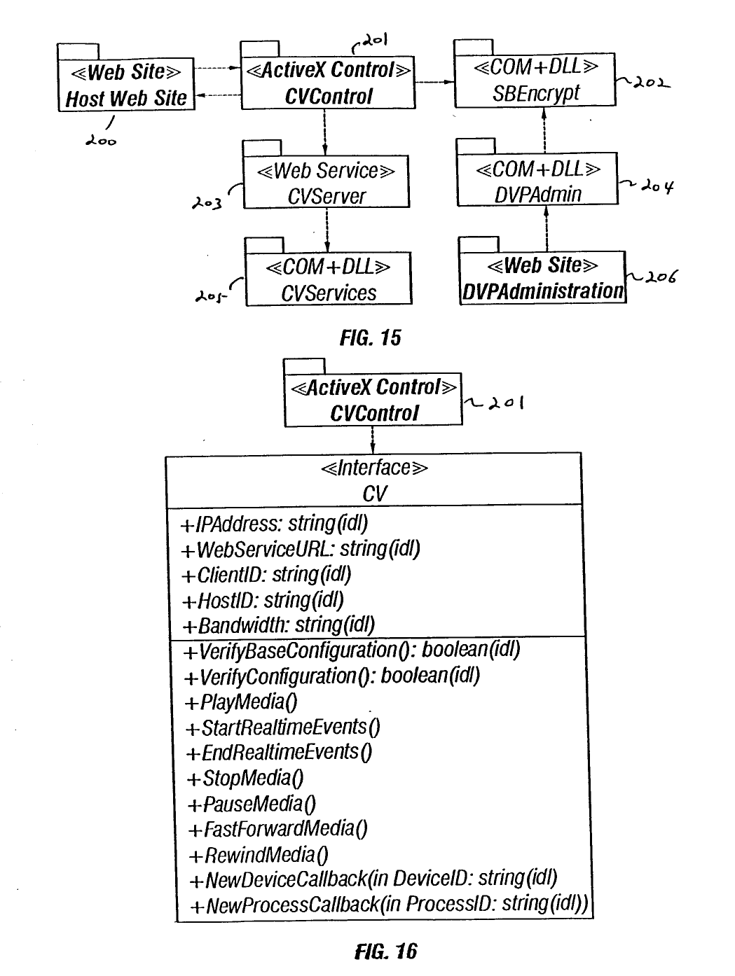

FIG. 15 illustrates a packaging diagram depicting the typical system entities that may be used directly or indirectly by the CVC 31 in accordance with the preferred embodiment of the present invention.

FIG. 16 illustrates what can be publicly visible properties and methods of the CVC 31 in accordance with the preferred embodiment of the present invention.

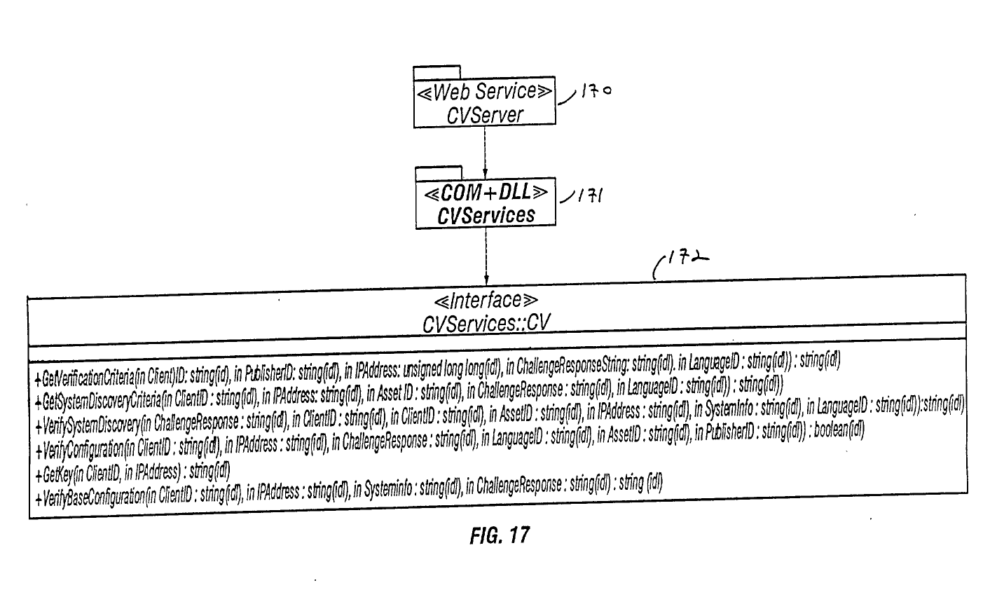

FIG. 17 illustrates a class diagram showing the methods used by CVS 34 to carry out its functions in accordance with the preferred embodiment of the present invention.

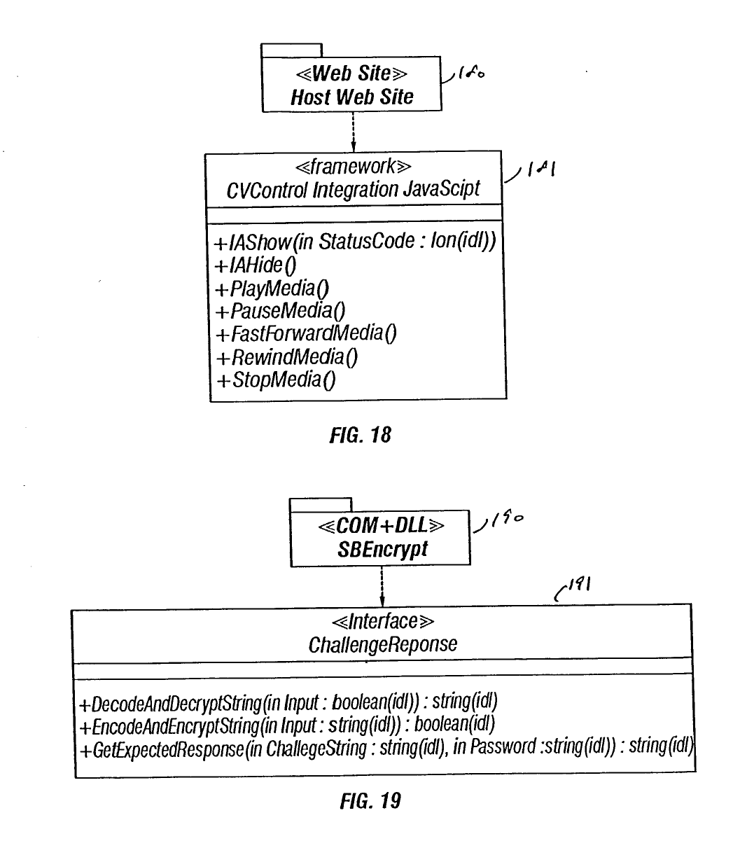

FIG. 18 shows an integration class diagram whereby a Java Script framework method that may be created by a web site host to integrate with the CVC 31 in accordance with the preferred embodiment of the present invention.

FIG. 19 illustrates an encryption diagram depicting the functionality exposed by the SNEncrypt.dll, which provides the SOAP challenge-Response security mechanism that may be used between the CVC 31 and the CVS 34 in accordance with the preferred embodiment of the present invention.

It should be noted that the present invention might be embodied in forms other than the preferred embodiments described above without departing from the spirit or essential characteristics thereof. The preferred embodiments are therefore to be considered in all aspects as illustrative and not restrictive, and all changes or alternatives that fall within the meaning and range or equivalency of the claims are intended to be embraced within them.

What we claim:

1. A system for preventing unauthorized duplication of digital media content distributed over a communication network to a client device capable of performing playback of the digital media content, said system comprising;
a media server for storing digital media content; and
a configuration verification server for receiving from the client device the configuration data of said client device, said configuration data including system configuration information of said client device,
wherein said configuration verification server uses the received configuration data of said client device to determine whether said client device is authorized to receive the stored digital media content for playback, and
wherein if said configuration verification server determines that the client device is authorized to receive the stored digital media content, said configuration verification server causes the stored digital media content to be delivered from the media server to the client device for playback.

2. The system of claim 1, further comprising a criteria server for storing sets of pre-approved configuration data, wherein said configuration verification server compares the received configuration data against said sets of pre-approved configuration data in order to determine whether the client device is authorized to playback the stored digital media content.

3. The system of claim 1, further comprising a threat repository server for storing sets of unauthorized configuration data, wherein said configuration verification server compares the received configuration data against said sets of unauthorized configuration data in order to determine whether the client device is authorized to playback the stored digital media content.

4. The system of claim 1, further comprising an application server that is operatively coupled to the client device and the media server for coordinating delivery of the stored digital media content from the media server to the client device.

5. The system of claim 1, wherein said client device includes means for detecting the configuration data of said client device and sending the detected configuration data to said configuration verification server.

6. The system of claim 1, wherein the stored digital media content includes video files, and wherein said client device includes a media viewer for viewing said video files.

7. The system of claim 1, wherein, during the delivery of the stored digital media content to the client device, the configuration verification server periodically receives from the client device updated configuration data, wherein the configuration verification server uses the received updated configuration data to determine whether the client device is still authorized to playback the stored digital media content, and wherein if the configuration verification server determines that the client device is no longer authorized to playback the stored digital media content, the configuration verification server causes the delivery of the stored digital media content to stop.

8. The system of claim 1, wherein the stored digital media content is delivered to the client device in encrypted format.

9. The system of claim 8, further comprising means for providing to the client device a decryption key to be used to decrypt the digital media content that is delivered to the client device in encrypted format.

10. A method for preventing unauthorized duplication of digital media content distributed over a communication network to a client device capable of performing playback of the digital media content, said method comprising the steps of:
storing digital media content;
receiving from the client device the configuration data of said client device, said configuration data including system configuration information of said client device;
using the received configuration data of said client device, determining whether said client device is authorized to playback the stored digital media content; and
causing the stored digital media content to be delivered to the client device for playback.

11. The method of claim 10, further comprising the steps of:
storing sets of pre-approved configuration data; and
comparing the received configuration data against said sets of pre-approved configuration data.

12. The method of claim 10, further comprising the steps of:
storing sets of unauthorized configuration data; and
comparing the received configuration data against said sets of unauthorized configuration data.

13. The method of claim 10, wherein the stored digital media content is delivered in encrypted format.

14. The method of claim 13, further comprising the step of providing a decryption key to the client device for decrypting the stored digital media content delivered in encrypted format.

15. The method of claim 10, further comprising the steps of:
during the delivery of the stored digital media content to the client device, receiving from the client device updated configuration data;
using the received updated configuration data, assessing whether the client device is still authorized to playback the stored digital media content; and
if the client device is assessed as no longer authorized to playback the stored digital media content, causing the delivery of the stored digital media content to stop.

16. A machine-readable medium containing a set of executable instructions for causing a computer to perform a method for preventing unauthorized duplication of digital media content distributed over a communication network to a client device capable of performing playback of the digital media content, said method comprising the steps of:
storing digital media content;
receiving from the client device the configuration data of said client device, said configuration data including system configuration information of said client device;
using the received configuration data of said client device, determining whether said client device is authorized to playback the stored digital media content; and
causing the stored digital media content to be delivered to the client device for playback.

17. The machine-readable medium of claim 16, wherein said method further comprises the steps of:
storing sets of pre-approved configuration data; and
comparing the received configuration data against said sets of pre-approved configuration data.

18. The machine-readable medium of claim 16, wherein said method further comprises the steps of:
storing sets of unauthorized configuration data; and
comparing the received configuration data against said sets of unauthorized configuration data.

19. The machine-readable medium of claim 16, wherein the method further comprises of steps of:
encrypting the stored digital media content to be delivered to the client device; and
providing to the client device a decryption for decrypting the encrypted stored digital media content.

20. The machine-readable medium of claim 16, wherein the method further comprises the steps of:
during the delivery of the stored digital media content to the client device, receiving from the client device updated configuration data;
using the received updated configuration data, assessing whether the client device is still authorized to playback the stored digital media content; and
if the client device is assessed as no longer authorized to playback the stored digital media content, causing the delivery of the stored digital media content to stop.

21. A system for preventing unauthorized duplication of digital media content distributed over a communication network to a client device capable of performing playback of the digital media content, said system comprising;
storing means for storing digital media content;
verification means for receiving from the client device the configuration data of said client device, said configuration data including system configuration information of said client device,
wherein said verification means uses the received configuration data of said client device to determine whether said client device is authorized to receive the stored digital media content and
wherein if said verification means determines that the client device is authorized to receive the stored digital media content, said verification means causes the stored digital media content to be delivered from the means to the client device for playback.

22. The system of claim 21, further comprising means for storing sets of pre-approved configuration data, wherein said verification means compares the received configuration data against said sets of pre-approved configuration data in order to determine whether the client device is authorized to playback the stored digital media content.

23. The system of claim 21, further comprising means for storing sets of unauthorized configuration data, wherein said verification means compares the received configuration data against said sets of unauthorized configuration data in order to determine whether the client device is authorized to playback the stored digital media content.

24. The system of claim 21, further comprising means for delivering the stored digital media content from the storing means to the client device.

25. The system of claim 21, wherein said client device includes means for detecting the configuration data of said client device and sending the detected configuration data to said configuration verification server.

26. The system of claim 21, wherein the stored digital media content includes video files, and wherein said client device includes means for viewing said video files.

27. The system of claim 21, wherein said communication network is the Internet.

28. The system of claim 21, wherein the stored digital media content is delivered to the client device in encrypted format.

29. The system of claim 28, further comprising means for providing to the client device a decryption key to be used to decrypt the digital media content that is delivered to the client device in encrypted format.

30. The system of claim 21, wherein, during the delivery of the stored digital media content to the client device, the verification means periodically receives from the client device updated configuration data, wherein the verification means uses the received updated configuration data to determine whether the client device is still authorized to playback the stored digital media content, and wherein if the verification means determines that the client device is no longer authorized to playback the stored digital media content, the verification means causes the delivery of the stored digital media content to stop.

31. A machine-readable medium containing a set of executable instructions for causing a microprocessor of a client device to perform a method of digital media content playback, said digital media content being distributed from a content provider over a communication network, said method comprising the steps of:
requesting from the content provider digital media content for playback;
detecting the system configuration information of the client device;
sending to the content provider the detected system configuration information;
receiving from the content provider authorization to receive the requested digital media content for playback.

32. The machine-readable medium of claim 31, wherein the method further comprises the steps of:
while receiving the requested digital media content for playback, periodically detecting updated system configuration information of the client device; and
sending to the content provider the updated system configuration information of the client device.

33. The machine-readable medium of claim 31, wherein the method further comprises the step of notifying the user of the client device of the status of the request for digital media content.

34. The machine-readable medium of claim 31, wherein the method further comprises the step of halting the step of receiving the requested digital media content for playback.

35. A system for distributing digital media content over a communication network to a client device capable of performing playback of the digital media content, said system comprising:
distribution means for distributing digital media content over the communication network in encrypted format;
verification means for receiving from the client device the configuration data of said client device, said configuration data including system configuration information of said client device,
wherein said verification means uses the received configuration data of said client device to determine whether said client device is authorized to receive the distributed digital media content for playback, and
wherein if said verification means determines that the client device is authorized to receive the distributed digital media content, said verification means provides to the client device a decryption key for decrypting the distributed digital media content for playback.

36. The system of claim 35, further comprising means for storing sets of pre-approved configuration data, wherein said verification means compares the received configuration data against said sets of pre-approved configuration data in order to determine whether the client device is authorized to receive the distributed digital media content.

37. The system of claim 35, further comprising means for storing sets of unauthorized configuration data, wherein said verification server compares the received configuration data against said sets of unauthorized configuration data in order to determine whether the client device is authorized to receive the distributed digital media content.

38. The system of claim 35, wherein said client device includes means for detecting the configuration data of said client device and sending the detected configuration data to said verification means.

39. The system of claim 35, wherein, after a decryption is provided to the client device, the verification means periodically receives from the client device updated configuration data, wherein the verification means uses the received updated configuration data to determine whether the client device is still authorized to receive the distributed digital media content, and wherein if the verification means determines that the client device is no longer authorized to receive digital media content being distributed, the verification means causes the client device to halt its reception of the digital media content.

40. The system of claim 35, wherein said communications network is the Internet.

41. A method for distributing digital media content over a communication network to a client device capable of performing playback of the digital media content, said method comprising the steps of:
distributing digital media content over the communication network in encrypted format;
receiving from the client device the configuration data of said client device, said configuration data including system configuration information of said client device;
using the received configuration data of said client device, determining whether said client device is authorized to receive the distributed digital media content for playback; and
providing to the client device a decryption key for decrypting the distributed digital media content if the client device is determined to be authorized to receive the distributed digital media content.

42. The method of claim 41, further comprising the steps of:
storing sets of pre-approved configuration data; and
comparing the received configuration data against said sets of pre-approved configuration data.

43. The method of claim 41, further comprising the steps of:
storing sets of unauthorized configuration data; and
comparing the received configuration data against said sets of unauthorized configuration data.

44. The method of claim 41, further comprising the steps of:
receiving from the client device updated configuration data;
using the received updated configuration data, assessing whether the client device is still authorized to receive the distributed digital media content; and
if the client device is assessed as no longer authorized to receive digital media content being distributed, stopping the distribution of the digital media content to the client device

45. The method of claim 41, wherein said communication network is the Internet.
